(19) United States
(12) Patent Application Publication
(10) Pub. No.: US 2024/0149918 A1
(43) Pub. Date: May 9, 2024

(54) NAVIGATION BASED ON INTERNAL STATE INFERENCE AND INTERACTIVITY ESTIMATION

(71) Applicants: Honda Motor Co., Ltd., Tokyo (JP); The Board of Trustees of the Leland Stanford Junior University, Stanford, CA (US)

(72) Inventors: Jiachen LI, Mountain View, CA (US); David F. ISELE, San Jose, CA (US); Kanghoon LEE, Daejeon (KR); Jinkyoo PARK, Palo Alto, CA (US); Kikuo FUJIMURA, Palo Alto, CA (US); Mykel J. KOCHENDERFER, Palo Alto, CA (US)

(21) Appl. No.: 18/231,665

(22) Filed: Aug. 8, 2023

Related U.S. Application Data
(60) Provisional application No. 63/420,224, filed on Oct. 28, 2022.

(51) Int. Cl. B60W 60/00; G06N 20/00

(52) U.S. Cl. CPC B60W 60/0027; G06N 20/00; B60W 2554/4041; B60W 2554/4042; B60W 2554/4046; B60W 2556/10

(57) ABSTRACT

Navigation based on internal state inference and interactivity estimation may include training a policy for autonomous navigation by extracting spatio-temporal features from one or more historical observations of one or more agents within a simulation environment including an ego-agent, analyzing the spatio-temporal features to infer one or more internal states of one or more of the agents, predicting one or more future behaviors for one or more of the one or more of the agents in a first scenario including an existence of the ego-agent within the simulation environment and in a second scenario excluding the existence of the ego-agent within the simulation environment, and calculating one or more interactivity scores for one or more of the agents based on a difference between the first scenario and the second scenario. The trained policy may be implemented to control an autonomous vehicle.

### CROSS-REFERENCE TO RELATED APPLICATIONS

This application claims the benefit of U.S. Provisional Patent Application, Ser. No. 63/420,224 (Attorney Docket No. HRA-53426) entitled “SYSTEM AND METHOD FOR PROVIDING AUTONOMOUS NAVIGATION WITH INTERNAL STATE INFERENCE AND INTERACTIVITY ESTIMATION”, filed on Oct. 28, 2022; the entirety of the above-noted application(s) is incorporated by reference herein.

### BACKGROUND

Controlling autonomous vehicles in urban traffic scenarios (e.g., intersections) may be a challenging sequential decision making problem which needs to consider complex interactions among heterogeneous traffic participants (e.g., human-driven vehicles, pedestrians) in dynamic environments. In such scenarios, human drivers may be able to reason about the relations between interactive entities, recognize other agents' intentions, and infer how their actions will affect the behavior of others on the road, allowing them to negotiate the right of way and drive efficiently. However, it may be desired for autonomous vehicles to accurately infer other drivers' internal states, including traits (e.g., conservative/aggressive) and intentions (e.g., yield/not yield).

### BRIEF DESCRIPTION

According to one aspect, a system for navigation based on internal state inference and interactivity estimation may include a processor and a memory. The memory may store one or more instructions. The processor may execute one or more of the instructions stored on the memory to perform one or more acts, actions, or steps. For example, the processor may perform training a policy for autonomous navigation by extracting spatio-temporal features from one or more historical observations of one or more agents within a simulation environment including an ego-agent, analyzing the spatio-temporal features to infer one or more internal states of one or more of the agents, predicting one or more future behaviors for one or more of the one or more of the agents in a first scenario including an existence of the ego-agent within the simulation environment and in a second scenario excluding the existence of the ego-agent within the simulation environment, and calculating one or more interactivity scores for one or more of the agents based on a difference between the first scenario and the second scenario.

The calculating one or more interactivity scores for one or more of the agents may be based on counter factual prediction. One or more of the internal states may be an aggressiveness level or a yielding level. One or more of the historical observations of one or more of the agents may be a position or a velocity. The extracting the spatio-temporal features from one or more of the historical observations of one or more of the agents may be performed by a graph-based encoder. The graph-based encoder may include a first long-short term memory (LSTM) layer, a graph message passing layer, and a second LSTM layer. The graph message passing layer may be positioned between the first LSTM layer and the second LSTM layer. An output of the first LSTM layer and an output of the second LSTM layer may be concatenated to generate final embeddings. The training the policy for autonomous navigation may be based on a Partially Observable Markov Decision Process (POMDP). Kullback-Leibler (KL) divergence may be used to measure the difference between the first scenario and the second scenario.

According to one aspect, a computer-implemented method for navigation based on internal state inference and interactivity estimation may include training a policy for autonomous navigation by extracting spatio-temporal features from one or more historical observations of one or more agents within a simulation environment including an ego-agent, analyzing the spatio-temporal features to infer one or more internal states of one or more of the agents, predicting one or more future behaviors for one or more of the one or more of the agents in a first scenario including an existence of the ego-agent within the simulation environment and in a second scenario excluding the existence of the ego-agent within the simulation environment, and calculating one or more interactivity scores for one or more of the agents based on a difference between the first scenario and the second scenario.

The calculating one or more interactivity scores for one or more of the agents may be based on counter factual prediction. One or more of the internal states may be an aggressiveness level or a yielding level. One or more of the historical observations of one or more of the agents may be a position or a velocity.

According to one aspect, a system for navigation based on internal state inference and interactivity estimation may include a processor, a memory, a storage drive, and a controller. The memory may store one or more instructions. The storage drive may store a policy for autonomous navigation. The processor may execute one or more of the instructions stored on the memory to perform one or more acts, actions, or steps. For example, the processor may perform training a policy for autonomous navigation by utilizing the policy for autonomous navigation. The policy for autonomous navigation may be trained by extracting spatio-temporal features from one or more historical observations of one or more agents within a simulation environment including an ego-agent, analyzing the spatio-temporal features to infer one or more internal states of one or more of the agents, predicting one or more future behaviors for one or more of the one or more of the agents in a first scenario including an existence of the ego-agent within the simulation environment and in a second scenario excluding the existence of the ego-agent within the simulation environment, and calculating one or more interactivity scores for one or more of the agents based on a difference between the first scenario and the second scenario. The controller may control the navigation based on internal state inference and interactivity estimation autonomous vehicle according to the policy for autonomous navigation and inputs from a vehicle sensor.

The calculating one or more interactivity scores for one or more of the agents may be based on counter factual prediction. One or more of the internal states may be an aggressiveness level or a yielding level. One or more of the historical observations of one or more of the agents may be a position or a velocity. The extracting the spatio-temporal features from one or more of the historical observations of one or more of the agents may be performed by a graph-based encoder. The graph-based encoder may include a first long-short term memory (LSTM) layer, a graph message passing layer, and a second LSTM layer.

### BRIEF DESCRIPTION OF THE DRAWINGS

FIG. 1 is an exemplary component diagram of a system for navigation based on internal state inference and interactivity estimation, according to one aspect.

FIG. 2 is an exemplary architecture in association with the system for navigation based on internal state inference and interactivity estimation of FIG. 1, according to one aspect.

FIG. 3 is an exemplary architecture in association with the system for navigation based on internal state inference and interactivity estimation of FIG. 1, according to one aspect.

FIG. 4 is an exemplary flow diagram of a computer-implemented method for navigation based on internal state inference and interactivity estimation, according to one aspect.

FIG. 5 is an exemplary flow diagram of a computer-implemented method for navigation based on internal state inference and interactivity estimation, according to one aspect.

FIG. 6A-6B are illustrations of exemplary scenarios in association with the system for navigation based on internal state inference and interactivity estimation of FIG. 1, according to one aspect.

FIG. 7 is an exemplary architecture in association with the system for navigation based on internal state inference and interactivity estimation of FIG. 1, according to one aspect.

FIG. 8 is an illustration of an example computer-readable medium or computer-readable device including processor-executable instructions configured to embody one or more of the provisions set forth herein, according to one aspect.

FIG. 9 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low velocity follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment which may be real or simulated. Exemplary agents may include robots, vehicles, or other self-propelled machines. The agent may be autonomously, semi-autonomously, or manually operated.

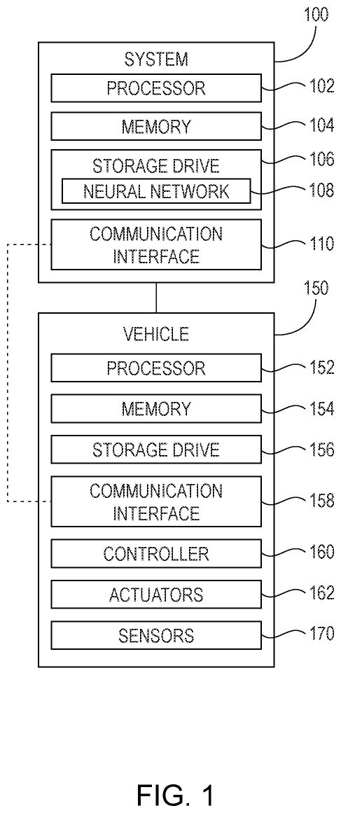

FIG. 1 is an exemplary component diagram of a system 100 for navigation based on internal state inference and interactivity estimation, according to one aspect. The system 100 for navigation based on internal state inference and interactivity estimation may include a processor 102, a memory 104, a storage drive 106 storing a neural network 108, and a communication interface 110. Respective components of the system 100 for navigation based on internal state inference and interactivity estimation may be operably connected. The memory 104 may store one or more instructions. The processor 102 may execute one or more of the instructions stored on the memory 104 to perform one or more acts, actions, or steps. The system 100 for navigation based on internal state inference and interactivity estimation may train a model or policy for autonomous navigation, according to one aspect.

For example, the processor 102 may perform training a policy for autonomous navigation by extracting spatio-temporal features from one or more historical observations of one or more agents within a simulation environment including an ego-agent, analyzing the spatio-temporal features to infer one or more internal states of one or more of the agents, predicting one or more future behaviors for one or more of the one or more of the agents in a first scenario including an existence of the ego-agent within the simulation environment and in a second scenario excluding the existence of the ego-agent within the simulation environment, and calculating one or more interactivity scores for one or more of the agents based on a difference between the first scenario and the second scenario.

The calculating one or more interactivity scores for one or more of the agents may be based on counter factual prediction. One or more of the internal states may be an aggressiveness level (e.g., Aggressive or Conservative) or a yielding level (e.g., Yield or Not Yield). One or more of the historical observations of one or more of the agents may be a position or a velocity. The extracting the spatio-temporal features from one or more of the historical observations of one or more of the agents may be performed by a graph-based encoder. The graph-based encoder may include a first long-short term memory (LSTM) layer, a graph message passing layer, and a second LSTM layer. The graph message passing layer may be positioned between the first LSTM layer and the second LSTM layer. An output of the first LSTM layer and an output of the second LSTM layer may be concatenated to generate final embeddings. The training the policy for autonomous navigation may be based on a Partially Observable Markov Decision Process (POMDP). Kullback-Leibler (KL) divergence may be used to measure the difference between the first scenario and the second scenario.

The communication interface 110 of the system 100 for navigation based on internal state inference and interactivity estimation may transmit the trained model or policy to an autonomous vehicle. The autonomous vehicle may include a processor 152, a memory 154, a storage drive 156 for storing the trained model or policy, a communication interface 158 for receiving the trained model or policy, a controller 160, actuators 162, and one or more vehicle sensors 170. Respective components of the system 100 for navigation based on internal state inference and interactivity estimation and/or the autonomous vehicle may be operably connected and/or in computer communication with one another. According to one aspect, the system 100 for navigation based on internal state inference and interactivity estimation may be implemented on the autonomous vehicle. The memory 154 may store one or more instructions. The storage drive 156 may store the policy for autonomous navigation. The processor 152 may execute one or more of the instructions stored on the memory 154 to perform one or more acts, actions, or steps.

The processor 102 may perform training a policy for autonomous navigation by utilizing the policy for autonomous navigation. The policy for autonomous navigation may be trained by extracting spatio-temporal features from one or more historical observations of one or more agents within a simulation environment including an ego-agent, analyzing the spatio-temporal features to infer one or more internal states of one or more of the agents, predicting one or more future behaviors for one or more of the one or more of the agents in a first scenario including an existence of the ego-agent within the simulation environment and in a second scenario excluding the existence of the ego-agent within the simulation environment, and calculating one or more interactivity scores for one or more of the agents based on a difference between the first scenario and the second scenario. The controller 160 may control the navigation based on internal state inference and interactivity estimation autonomous vehicle according to the policy for autonomous navigation and inputs from vehicle sensors 170 or a mobile device.

Deep Reinforcement Learning (DRL) may provide a promising way for intelligent agents (e.g., autonomous vehicles) to learn to navigate in complex scenarios. However, known DRL methods with deep neural networks offer little explainability and usually suffer from sub-optimal performance especially for autonomous navigation in highly interactive multi-agent environments. To address these issues, three auxiliary tasks with spatio-temporal relational reasoning are provided and integrated into a DRL framework, which may improve the decision making performance and provide explainable intermediate indicators. The system 100 for navigation based on internal state inference and interactivity estimation may explicitly infer the internal states (e.g., traits and intentions) of surrounding agents (e.g., human drivers) and predict their future trajectories in the situations with and without the ego-agent using counterfactual reasoning.

These auxiliary tasks may provide additional supervision signals to infer the behavior patterns of other interactive agents. Multiple variants of framework integration strategies may be compared. One or more spatiotemporal graph neural networks may be employed to encode relations between dynamic entities (e.g., agents), which may thereby enhance both internal state inference and ego decision making. Moreover, an interactivity estimation mechanism based on the difference between predicted trajectories in these two situations may be provided, which may indicate the degree of influence of the ego-agent on other agents. An intersection driving simulator based on an Intelligent Intersection Driver Model including vehicles and pedestrians may be utilized. Additionally, the navigation based on internal state inference and interactivity estimation may achieve robust and state-of-the-art performance in terms of standard evaluation metrics and provide explainable intermediate indicators (e.g., internal states, and interactivity scores).

Conservative drivers may generally yield to other traffic participants during interactions, keep a larger distance from leading vehicles, and maintain a lower desired velocity, while aggressive drivers may do the opposite. To increase driving efficiency while maintaining safety, autonomous vehicles may desire to accurately infer internal states of others, including traits (e.g., conservative/aggressive) and intentions (e.g., yield/not yield). Besides these high-level cues, accurate opponent (e.g., other agents) modeling in the form of multi-agent trajectory prediction may provide additional cues for safe and efficient decision making. Additional supervision from driver intention recognition and trajectory prediction may be utilized to enhance performance.

Navigation based on internal state inference and interactivity estimation may provide a mechanism to estimate the interactivity between the ego-agent and other surrounding agent by determining a difference between predicted trajectory distributions of each agent under scenarios with and scenarios without the existence of the ego-agent as a quantitative indicator. This difference may be treated as a quantitative degree of influence that the ego-agent may have on a given agent, which may be referred to as an “interactivity score”. The interactivity score may be used to weigh prediction errors in a loss function, which may encourage the model to generate more accurate trajectories for the agents that have stronger interactions with the ego-agent. The ego-agent may exist in both training and testing environments, and thus, predicting the future behaviors of other agents without the existence of the ego-agent may be framed as a counterfactual reasoning problem. According to one aspect, navigation based on internal state inference and interactivity estimation may use a prediction model pre-trained with the trajectory data collected in the environments without the ego-agent to generate counterfactual predictions during the training process. The weights of the prediction model may be fixed without further updates.

The ability to understand and reason about the interactions between dynamic entities (e.g., agents) by modeling their spatio-temporal relations may be desired. A multi-agent system may be represented as a graph, where node attributes encode the information of agents and where edge attributes encode agent relations or interactions. Graph neural networks (GNN) may capture relational features and model interactions between multiple entities in this way. Navigation based on internal state inference and interactivity estimation may employ a spatio-temporal graph neural network as the basis model for spatio-temporal relational reasoning.

Deep reinforcement learning navigation based on internal state inference and interactivity estimation for interactive autonomous navigation with three auxiliary tasks: internal state inference, trajectory prediction, and interactivity estimation may be provided herein, along with the consideration of multiple variants of framework architectures, as will be described in greater detail herein.

The auxiliary tasks may improve the decision making performance but also enhance the explainability of navigation based on internal state inference and interactivity estimation by inferring explainable, intermediate features of surrounding agents. In particular, explainable systems and techniques for navigation based on internal state inference and interactivity estimation to estimate interactivity scores based on the ego-agent's degree of influence on surrounding agents through counterfactual reasoning is discussed herein.

An Intelligent Intersection Driver Model may be provided herein to simulate interactive vehicle and pedestrian behaviors in a partially controlled intersection scenario, which may be used to validate the navigation based on internal state inference and interactivity estimation.

Navigation based on internal state inference and interactivity estimation may infer intentions to model different internal aspects and randomness in human behaviors. Different variants of framework architectures may be implemented to incorporate the internal state inference. The auxiliary tasks of trajectory prediction and interactivity estimation may be introduced into the reinforcement learning (RL) framework, which may improve the decision making performance and enhance the explainability of navigation based on internal state inference and interactivity estimation. An intersection driving simulator with crossing pedestrians based on IIDM may be utilized to validate the navigation based on internal state inference and interactivity estimation.

Partially Observable Markov Decision Process (POMDP)

A Markov Decision Process (MDP) may be used to describe a discrete-time stochastic sequential decision making process where an agent interacts with the environment. An MDP may be specified by the tuple (S, A, T, R, γ, ρ₀) where S and A denote the state and action space, T may denote the transition model, R may denote the reward, γ∈[0, 1] may denote the discount factor, and P o may denote the initial state distribution. A partially observable Markov decision process (POMDP) may be a generalization of the MDP, where the agent cannot directly observe the complete state. An additional observation function Ω may be utilized to map a state s∈S to an observation o∈O where O may denote the observation space. A POMDP may be specified by the tuple (S, A, T, R, Ω, O, γ, ρ₀). Unlike the policy function in the MDP which maps states to actions, the policy of a POMDP may map the historical observations or belief states to actions. The objective may be to find a policy Tr that maximizes the expected return:

$${π}^{*} = arg {max}_{π} {𝔼}_{{s}_{0} , {a}_{0} , {o}_{0} , …} {\sum }_{t = 0}^{∞} {γ}^{t} R ( {s}_{t} , {a}_{t} ) \qquad ( 1 )$$

where s₀˜ρ₀(s₀), aₜ˜π(aₜ|o_{1:t}), oₜ˜Ω(oₜ|sₜ), sₜ₊₁˜T(sₜ₊₁|sₜ, aₜ), and t denote the index of time steps.

### Policy Optimization

Policy gradient methods may be used to learn optimal policies by optimizing the policy parameters directly. The REINFORCE algorithm provides an unbiased gradient estimator with the objective L^{PG}(θ)= [symbol] [log π_{θ}(a|s)A], where A may be the estimated advantage. For a POMDP, the observation and the hidden state of the policy may be utilized, rather than the state s. Proximal Policy Optimization (PPO) may use policy optimization algorithm due to its simplicity and stable training performance, in which a clipped surrogate objective may be maximized:

$${L}^{P P O} ( θ ) = \hat{𝔼} [ min ( r ( θ ) \hat{A} , clip ( r ( θ ) , 1 - ϵ , 1 + ϵ ) \hat{A} ) ] \qquad ( 2 )$$

$$r ( θ ) = \frac{{π}_{θ} ( a \vert s )}{{π}_{{θ}^{′}} ( a \vert s )} \qquad ( 3 )$$

where θ′ may denote the parameters of an old policy used to collect experiences, and ϵ may denote a clipping threshold.

### Graph Neural Networks (GNN)

A graph neural network (GNN) may be from a class of deep learning models that may be applied to process the information on graph data. A specific design of the message passing mechanism may incorporate certain relational inductive biases into the model. Generally, graphs may be attributed (e.g., node attributes, edge attributes) in the context of graph neural networks. There may be two basic GNN operations in graph representation learning: an edge update and a node update. A graph with N nodes may be denoted as [symbol] ={V,ε}, where V={vᵢ|i∈{1, . . . , N}} may be a set of node attributes and ε={eᵢⱼ|i,j∈{1, . . . , N}} may be a set of edge attributes. The two update operations may be:

e′ᵢⱼ=ϕ^{e}(eᵢⱼ,vᵢ,vⱼ),ē′ᵢ=f^{e→v}(E′ᵢ),v′ᵢ=ϕ^{v}(ē′ᵢ,vᵢ) (4)

where E′ᵢ={ē′ᵢⱼ|j∈ [symbol] ⁱ}, E′=∪E′ᵢ, V′={v′ᵢ|i=1, . . . , n}, and [symbol] ⁱ may be the direct neighbors of node i. ϕ^{e}(⋅) and ϕ^{v}(⋅) may be denoted as neural networks. f^{e→v}(⋅) may be denoted as an aggregation function with the property of permutation invariance, where s may be a distance from a leading vehicle, v may be a longitudinal velocity, Δv may be an approaching rate, δ may be a free-drive exponent, s₀ may be a minimum desired distance from a leading vehicle, v* may be a desired velocity, T may be a desired time gap, aₘₐₓ may be a maximum acceleration, and b_{comf} may be a comfortable or target braking deceleration.

### Intersection Driving Simulation

An Intelligent Intersection Driver Model may be provided for simulating low-level vehicle kinematics and pedestrian behaviors that consider the interactions between traffic participants. A simulator of a partially controlled intersection may be developed which includes vehicles (e.g., agents) and pedestrians.

### Intelligent Intersection Driver Model (IIDM)

The IIDM may be a one-dimensional vehicle-following model with tunable parameters that drive along a reference path. In the canonical Intersection Driver Model (IDM), the longitudinal position and velocity in Frenot coordinates may be computed by:

$$\frac{d v}{d t} = {a}_{max} [ 1 - {( \frac{v}{{v}^{*}} )}^{δ} - {( \frac{{s}^{*} ( v , Δ v )}{s} )}^{2} ] \qquad ( 5 )$$

$${s}^{*} ( v , Δ v ) = {s}_{0} + T v + \frac{v Δ v}{2 \sqrt{{a}_{max} {b}_{comf}}} \qquad ( 6 )$$

Equations (5), (6) may serve as a low-level vehicle kinematics model.

To consider other dynamic agents that may be relevant to a certain vehicle, three types of interactions may be defined: Yield, Not Yield, and Follow interaction types. Yield may be defined as slowing down until a complete stop to mitigate collisions when a conflict exists. The Yield interaction type may apply to vehicles or agents whose future paths intersect with a crosswalk with crossing pedestrians. The Yield interaction type may apply to the vehicles or agents which may encounter unyielding crossing traffic to mitigate collisions.

According to one aspect, this may be implemented by placing a virtual static leading vehicle at a stop line or at a conflict point, and having the simulated vehicle move according to Equations (5), (6).

Not Yield interaction type may be defined as passing the conflict point first without slowing down or stopping when two vehicles have a conflict in their future paths.

Follow interaction type may be defined to describe a pair of vehicles that move along the same reference path, where Equations (5), (6) may be directly applied.

### Driving Simulator

A simulator of vehicles and pedestrians may be developed for a partially controlled intersection with two-way stop signs. The ego-agent may be randomly initialized on a branch with stop signs and the crossing traffic may be not constrained. Multiple simulated vehicles may drive in the crossing traffic lanes and the opposing direction, and multiple pedestrians may walk on sidewalks and crosswalks within the simulator.

For the simulated vehicles, a human driver may be sampled to be Aggressive or Conservative uniformly at a beginning of an episode. The driver may be sampled to have an intention to Yield or Not Yield with P(Yield|Conservative)=0.9 and P(Yield|Aggressive)=0.1. This may be to imitate the fact that both aggressive and conservative drivers may choose to Yield or Not Yield due to the inherent randomness in human decisions regardless of their traits. According to one aspect, the differences between heterogeneous driver behaviors on the horizontal lanes may be defined as follows, although other definitions may be utilized:

Aggressive and non-yielding drivers have the desired velocity of 3.0 m/s and a minimum distance from the leading vehicle of 3.0 m-5.0 m;

Aggressive and yielding drivers have the desired velocity of 2.8 m/s and a minimum distance from the leading vehicle of 3.25 m-5.25 m;

Conservative and yielding drivers have the desired velocity of 2.4 m/s and a minimum distance from the leading vehicle of 4.0 m-6.0 m;

Conservative and non-yielding drivers have the desired velocity of 2.6 m/s and a minimum distance from the leading vehicle of 3.75 m-5.75 m.

Simulated pedestrians may be added on the crosswalks and sidewalks. It may be assumed that pedestrians have the highest right of way and move with constant velocity unless another agent is directly in front of the pedestrian, in which case the pedestrian may stay still until the path is clear. In general, all vehicles should yield, in the simulation, to pedestrians whenever there is a conflict between their future paths within a predetermined time horizon.

### Problem Formulation

The autonomous navigation of the ego-agent may be formulated as a POMDP. The POMDP components may be defined as follows:

State: it may be assumed that there are N surrounding vehicles in a scene, where x=[x⁰, x¹, x², . . . x^{N}] may denote the physical state, where x⁰=[x⁰, y⁰, vₓ⁰, v_{y}⁰, b⁰] may denote the ego-agent state position, velocity and one-hot indicator of agent type (e.g., vehicle/pedestrian), and where xⁱ=[xⁱ, yⁱ, vₓⁱ, v_{y}ⁱ, b], i∈{1, . . . , N} may denote the state of the i-th surrounding agent. An internal state of the surrounding drivers may be represented as z=[z¹, z², . . . x^{N}]. The internal state of each human driver may include two components: z₁ⁱ∈{Conservative, Aggressive} and z₂ⁱ∈{Yield, Not Yield}. It may be assumed that there are M pedestrians in the scene, and the M pedestrian's physical states may be denoted as x^{N+1:N+M}=[x^{N+1}, x^{N+2}, . . . , x^{N+M}]. The joint state may be represented by:

s=[x⁰,(x¹,z¹), . . . ,(x^{N},z^{N}),x^{N+1}, . . . ,x^{N+M}] (7)

Observation: it may be assumed that the physical states of the surrounding vehicles and pedestrians may be observable to the ego-agent, while the internal states may be not observable. The observation may be represented by o=[\hat{x}⁰, . . . , \hat{x}^{N+M}], where \hat{x}ⁱ may be obtained by adding a little noise sampled from a zero-mean Gaussian distribution to the actual position and velocity to simulate sensor noise.

Action: it may be assumed that the action a∈{0.0, 0.5, 3.0} m/s may be defined as the target velocity of the ego-agent for a low-level controller or controller 160 to track.

Transition: it may be assumed that the interval between consecutive simulation steps may be 0.1 s. The behaviors of surrounding vehicles and pedestrians may control the vehicle with a longitudinal proportional-derivative (PD) controller or controller 160, following the left-turn reference path and tracking the target velocity determined by the ego policy. A check may be made to determine if the distance between the ego-agent and other agents is less than a desired threshold distance. The episode within the simulation may be determined to end or finish when the ego-agent completes the left turn successfully, a collision happens, or the maximum horizon is reached.

Reward: a reward function that encourages the driving policy to control the ego-agent to turn left at the intersection as fast as possible without collisions may be provided. For example, the reward function may be represented as R(s, a)=1{s∈S_{goal}}r_{goal}+1{s∈S_{col}}r_{col}+r_{velocity}(s), where r_{goal}=2 and S_{gola} may be a set of goal states where the ego-agent completes a left turn successfully. r_{col}=−2 and S_{col} may be a set of failure states where a collision occurs and

$${r}_{v e l o c i t y} ( s ) = 0.01 \frac{‖ {v}_{e g o} ‖}{3. m / s}$$

may be a small reward associated with the ego-agent's velocity to encourage efficient driving.

### Deep Reinforcement Learning With Internal State Inference

Different variants of deep reinforcement learning with different configurations of human internal state inference for autonomous navigation in complex interactive scenarios may be provided. Differences between these architectures may lie in the training strategies and the way to incorporate the internal state inference network into these DRL frameworks.

### Internal State Inference

Consider an urban traffic scenario with the presence of the ego-agent, N surrounding vehicles, and M pedestrians, where the ego-agent may be controlled by a reinforcement learning policy and the surrounding vehicles may be controlled by N human drivers, as defined in the simulator. Let xₜ denote the physical state of all the vehicles and pedestrians at time step t, model the action distribution of the ith human driver as p(aₜⁱ)|xₜ,zₜⁱ, where zₜⁱ may represent the driver's internal state: trait (e.g., aggressive/conservative) and intention (e.g., yield/not yield to the ego-agent).

Inferring the internal state of the surrounding drivers may provide several benefits or advantages. First, a discrete internal state may be efficient to learn and simple to be integrated into the control policy. Second, in many situations or scenarios, the internal state may provide more distinguishable information than merely predicting their future trajectories. For example, the predicted trajectories of the conservative and aggressive vehicles could be similar at the moment before the ego-agent approaches the intersection, which may not be indicative of their driving traits effectively. However, these traits may be inferred by observing their interaction histories with other vehicles. In such cases, the internal state may provide information explicitly for the ego decision making.

One goal of internal state inference may be to determine the distribution p(zₜⁱ|o_{1:t}), where o_{1:t} may denote the ego-agent's historical observations up to time t. It may be assumed that the ground truth internal states of the surrounding human drivers are available from the simulator at training time and unknown at testing time. Therefore, an internal state inference module (e.g., a neural network, implemented via the processor) may be trained by supervised learning as a classification task. By using the information provided by the internal state labels, the auxiliary trait and intention inference tasks provide additional supervision signals in addition to a reinforcement learning framework.

### Graph-Based Representation Learning

A human driver's behavior in complex and dense traffic scenarios may be heavily influenced by the driver's relations to other traffic participants. The dependence between traffic participants may be represented as a graph where the nodes represent agents and the edges represent their relations or interactions. In a four-way intersection scenario, each vehicle or agent may be potentially influenced by any surrounding agents. Based on this, the intersection scenario at time t may be represented as a fully connected graph [symbol] ₜ=(Vₜ,εₜ) where the node set Vₜ includes the nodes for all the vehicles and pedestrians in the scene, and the edge set εₜ includes all the directed edges between each pair of agents. The edges may be designed to be directed because the influence between a pair of agents may not be symmetrical. In other words, bidirectional relations may be modeled individually. For example, the leading vehicle tends to have a strong influence on the behavior of the following ones in the same lane. However, the following vehicles merely have a minor influence on the leading one. The asymmetry also applies to situations where two conflicting agents have different priorities of the right of way such as vehicle-pedestrian interactions.

According to one aspect, a three-layer network architecture may be implemented to process both the spatial relational information in [symbol] ₜ with a graph message passing layer and the temporal information in o tt with a long-short term memory (LSTM) recurrent network layer. At time step t, the observation on the i-th vehicle oₜⁱ and its observation history o_{1:t-1}ⁱ may be fed into a bottom-level Vehicle-LSTM with a hidden state hₜⁱ. The Vehicle-LSTM parameters may be shared among all the vehicles except the ego-agent. Similarly, a shared Pedestrian-LSTM may be utilized to extract historical features for pedestrians. Thus:

vₜ⁰=Ego-LSTM¹(oₜ⁰;hₜ⁰)

vₜⁱ=Vehicle-LSTM¹(oₜⁱ;hₜⁱ),i∈{1, . . . ,N}

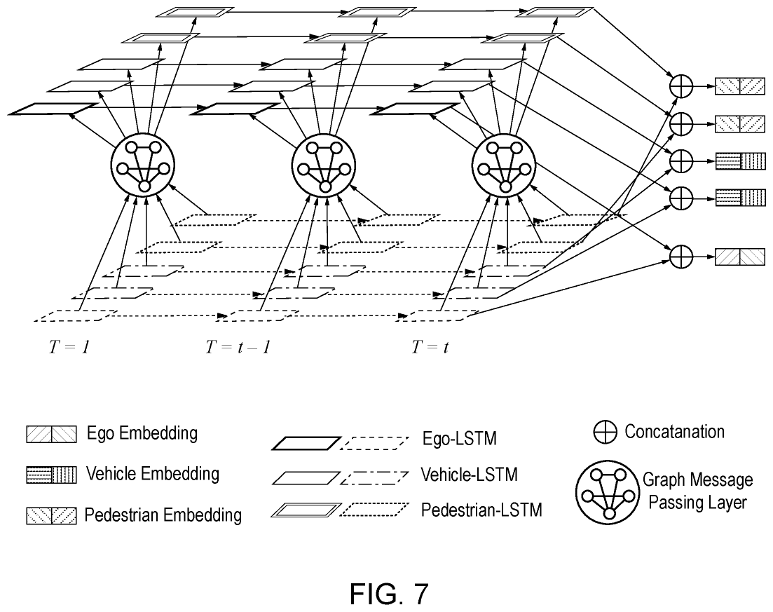

vₜⁱ=Pedestrain-LSTM¹(oₜⁱ;hₜⁱ),i∈{N+1, . . . ,N+M} (8)

where vₜ⁰ and vₜⁱ may denote the extracted feature vectors of the ego-agent and surrounding traffic participants, which encode their historical behaviors. Ego-LSTM¹, Vehicle-LSTM¹, and Pedestrian-LSTM¹ may denote the LSTM units at the bottom layer of FIG. 7, for example.

The extracted features vₜ⁰ and vₜⁱ may be used as the initial node attributes of the corresponding agents in [symbol] ₜ. The effectiveness of three graph message passing layers may be explored to process the information across the graph using: GAT, GCN, and GraphSAGE. Message passing mechanisms may be adapted to the setting as follows:

### Graph Attention Network (GAT)

For GAT, the model may apply a soft attention mechanism to graphs. The attention coefficients may be computed by:

$${α}_{t}^{ij} = \frac{exp ( Leaky Re LU ( {a}^{T} [ W {v}_{t}^{i} \vert \vert {Wv}_{t}^{j} ] ) )}{{\sum }_{k ∈ {𝒩}^{i}} exp ( Leaky Re LU ( {a}^{T} [ W {v}_{t}^{i} \vert \vert {Wv}_{t}^{k} ] ) )} \qquad ( 9 )$$

where a and W may denote a learnable weight vector and a learnable weight matrix, [symbol] ⁱ may denote the direct neighbors of node i. The symbols ⋅^{T} and ∥ may denote transposition and concatenation operations, respectively. The updated node attributes may be obtained by:

v̅ₜⁱ=σ( [symbol] αₜ^{ij}Wvₜ^{j}) (10)

where σ(⋅) may denote a non-linear activation function.

### Graph Convolutional Network (GCN)

For GCN, the model may apply convolution operations to graphs. A node attribute matrix V may be formulated, where each row may denote the attribute of a certain node. The updated node attribute matrix V may be obtained by:

$${\overline{V}}_{t} = σ ( {\tilde{D}}^{- \frac{1}{2}} \tilde{A} {\tilde{D}}^{- \frac{1}{2}} {V}_{t} W ) \qquad ( 11 )$$

where Ã=A+I may be the adjacency matrix of [symbol] ₜ with self-connections. I may be the identity matrix. \tilde{D}ⁱⁱ=ΣⱼĄ^{ij} and W may be a learnable weight matrix. σ(⋅) may denote a non-linear activation function.

### GraphSAGE

For GraphSAGE, the model may design a customized message passing mechanism, which includes the following operations:

MSGₜⁱ=f_{AGG}({v^{j}|∀ⱼ∈ [symbol] ⁱ}) (12)

v̅ₜⁱ=σ(W[vₜⁱ∥MSGₜⁱ]) (13)

\tilde{v}ₜⁱ←v̅ₜⁱ/∥v̅ₜⁱ∥₂ (14)

where MSGₜⁱ may denote an intermediate message obtained by aggregating the information from the neighbors of node i, and f_{AGG} may be an arbitrary permutation invariant function. W may denote a learnable weight matrix and σ(⋅) may denote a non-linear activation function.

The updated node attributes may be then fed into the top-level LSTM networks with the same parameter-sharing strategy, which may be written as:

\tilde{v}ₜ⁰=Ego-LSTM²(v̅ₜ⁹;h̅ₜ⁰)

\tilde{v}ₜⁱ=Vehicle-LSTM²(v̅ₜⁱ;h̅ₜⁱ),i∈{1, . . . ,N}

\tilde{v}ₜⁱ=Pedestrain-LSTM²(v̅ₜⁱ;h̅ₜⁱ),i∈{N+1, . . . ,N+M} (15)

where Ego-LSTM², Vehicle-LSTM², and Pedestrian-LSTM² may denote the LSTM units at the top layer of FIG. 7, for example. Variables h̅ₜ⁰ and h̅ₜⁱ may be the corresponding hidden states. The final feature embedding of agent i at time t may be obtained by a concatenation of vₜⁱ and \tilde{v}ₜⁱ, which may encode both the self-attribute and social-attribute.

A multi-layer perceptron (MLP) may take the final embeddings of surrounding vehicles as input and outputs the probability of the corresponding human driver's traits (e.g., aggressive/conservative) and intentions (e.g., yield/not yield). According to one aspect, pedestrian node attributes may be used for message passing, yet pedestrian node attributes may be not used for internal state inference.

### Framework Architectures

The human internal state inference may be integrated into the RL-based autonomous navigation framework as an auxiliary task. The integration may be done in multiple ways. Five variants of framework architectures are described herein. In these variants, ground truth internal states may be obtained from the environment (e.g., driving simulator) during training, and the internal state inference network may be trained with cross-entropy loss. Details and the differences among these variants are discussed in greater detail below. Through the comparison between these variants, different combinations of model integration and training strategies may be seen and explored.

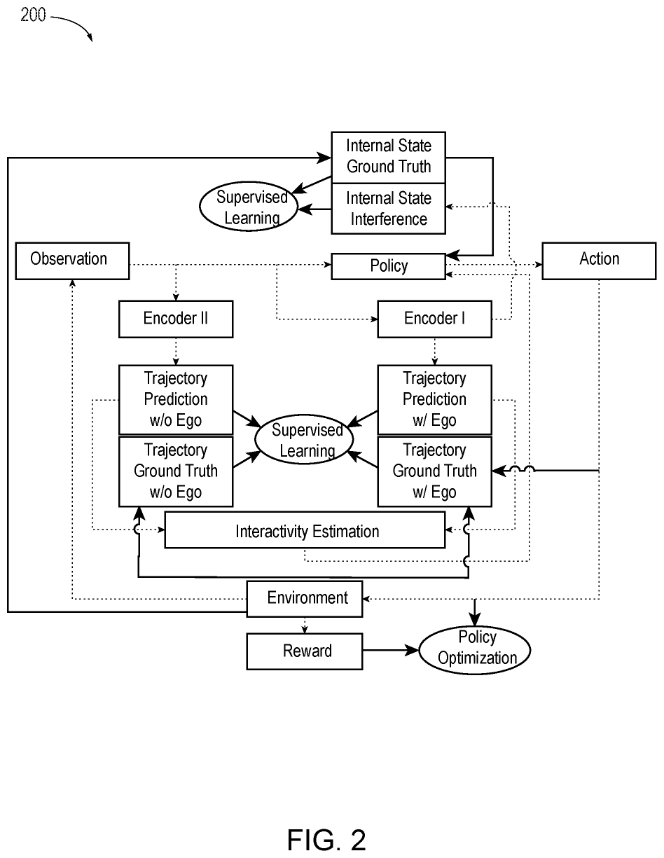

FIG. 2 is an exemplary architecture 200 in association with the system 100 for navigation based on internal state inference and interactivity estimation of FIG. 1, according to one aspect, during a training phase.

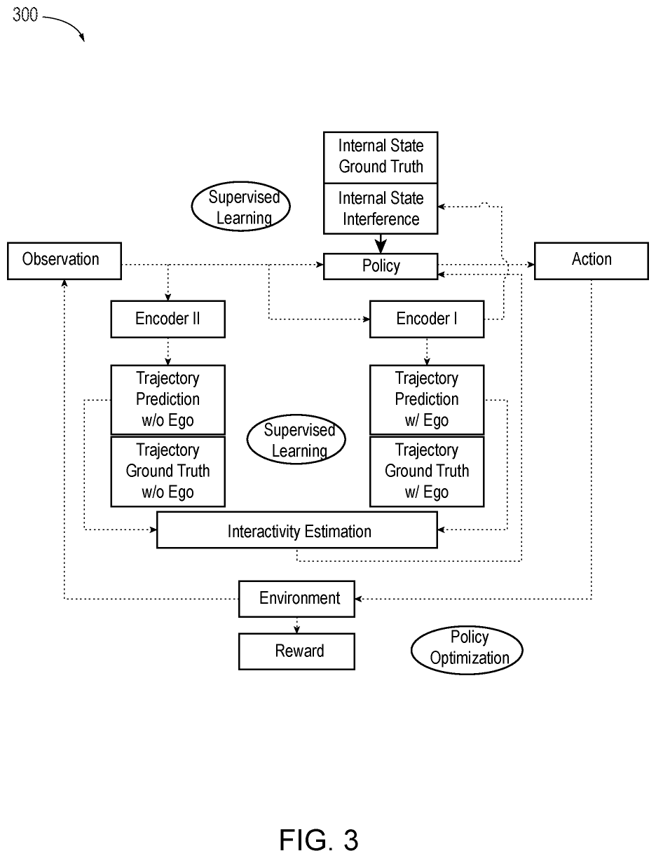

FIG. 3 is an exemplary architecture 300 in association with the system 100 for navigation based on internal state inference and interactivity estimation of FIG. 1, according to one aspect, during a testing phase.

With reference to FIGS. 2-3, the policy network and the internal state inference network may be treated as two separate modules without mutual influence during training. During training (e.g., FIG. 2), the policy network may leverage the historical observations and true internal states that provide the actual traits and intentions of surrounding vehicles. The graph-based encoder may be used for internal state inference. The policy may be refined by a policy optimization algorithm. Meanwhile, the internal state inference network may be trained by supervised learning separately. During testing (e.g., FIG. 3), the policy network may leverage the inferred internal states instead.

The internal state inference network may learn the mapping from the historical observations to a latent distribution, e.g., p_{ψ}(zₜⁱ|o_{1:t}), where ψ may denote the parameters of the inference network that may be trained to minimize the negative log-likelihood:

L(ψ)=− [symbol] _{z}_{ₜ}_{ⁱ}_{,o}_{_{1:t}}_{˜D}[log p_{ψ}(zₜⁱ|o_{1:t})] (16)

where the latent state zₜⁱ and the historical observations o_{1:t} may be randomly sampled from a replay buffer containing exploration experiences. The policy may take both the historical observations and the internal state as inputs, e.g., π_{θ}(a|o_{1:t}, zₜ^{1:N}), where θ may denote the policy network parameters trained by the augmented policy optimization objective:

$$L ( θ ) = \hat{𝔼} [ min ( \frac{{π}_{θ} ( a \vert {o}_{1 : t} {z}_{t}^{1 : N} )}{{π}_{{θ}^{′}} ( a \vert {o}_{1 : t} , {z}_{t}^{1 : N} )} \hat{A} , clip ( \frac{{π}_{θ} ( a \vert {o}_{1 : t} {z}_{t}^{1 : N} )}{{π}_{{θ}^{′}} ( a \vert {o}_{1 : t} {z}_{t}^{1 : N} )} , 1 - ϵ , 1 + ϵ ) \hat{A} ) ] \qquad ( 17 )$$

According to another aspect, the policy network and internal state inference network may share the same encoder during both training and testing. Thus, the two networks may influence each other via the shared encoder. Both supervised learning loss and policy optimization loss may update the encoder.

According to another aspect, the policy network may use the inferred internal states during both training and testing. The internal state labels may be used to train the inference network. The quality of the information about internal states used by the policy network may depend on the inference accuracy.

According to another aspect, the policy network and internal state inference network may share the same encoder during both training and testing.

According to another aspect, the losses from two tasks may be coupled by a weighted sum and all the networks may be trained with the policy optimizer. The variant may have the most correlation between the policy network and the internal state inference network.

The architectures of FIGS. 2-3 may feed the ground truth internal state at exploration (e.g., training) time which may help the control policy find the trajectory leading to the task goal. This may be useful when the task may be difficult and the reward is sparse. By using a separate network for each task, the mutual influence (e.g., which may not be desired) of the gradients from different tasks may be minimized. By modularizing the two learning modules, the framework or architectures of FIGS. 2-3 may enable flexible choices of network structures in different modules.

Besides inferring the high-level internal states of human drivers, the autonomous navigation task may benefit from forecasting their future trajectories to provide fine-grained behavioral cues as well as reasoning about the potential influence of the ego-agent on surrounding agents. An auxiliary trajectory prediction task may be designed to infer how the other traffic participants will behave in the presence of the ego-agent. Moreover, in complex urban traffic, human drivers tend to implicitly estimate to what extent they could influence the behaviors of other traffic participants to enhance situational awareness and facilitate their negotiation and driving efficiency. In this way, a mechanism to estimate the interactivity scores of other agents that may be used by the policy network may be provided.

To predict the future trajectories of other agents in both situations and quantify the difference as interactivity scores, which may be used as input to the ego policy network. Moreover, since the ego-agent tends to negotiate with the agents with large interactivity scores, the trajectory prediction of those agents may be desired to be more accurate than those with small interactivity scores to facilitate efficiency. Therefore, a weighting strategy in the prediction loss based on the interactivity scores to encourage better prediction of important agents that may have strong interactions with the ego-agent. In both training and testing scenarios, the ego-agent may exist and influence the other agents, and thus, the prediction in the situation without the ego-agent may be treated as counterfactual reasoning.

### Trajectory Prediction

The trajectory prediction task may be formulated as a regression problem solved by supervised learning, where the ground truth future trajectories may be obtained by simulation. The simulation may provide additional supervision signals to refine the graph representation learning in the encoder and thus help with the improvement of other downstream components. Future trajectories of surrounding agents may be forecasted in both situations (e.g., without the existence of the ego-agent and with the existence of the ego-agent) through two separate prediction heads. The former task may encourage the model to capture natural behaviors of surrounding agents defined by the simulation without the intervention of the learned ego-agent's policy. The latter task may encourage the model to capture how the surrounding agents will react to the ego-agent's future behavior through their future trajectories.

The prediction horizon may be denoted as T_{f} and the objective of prediction may be to estimate two conditional distributions p(x_{t+1:t+T}_{_{f}}^{1:N+M}|o_{1:t}^{1:N+M}) (e.g., without the ego-agent) and p(x_{t+1:t+T}_{_{f}}^{1:N+M}|o_{1:t}) (e.g., with the ego-agent). The distributions may be assumed to be Gaussian with a fixed diagonal covariance matrix Σ. Thus, the model may predict the mean of distributions.

To predict future trajectories in the scenarios without the ego-agent, another prediction model branch may be pre-trained including a graph-based encoder except that there may be no ego-agent involved as well as an MLP prediction head. The parameters of these networks may be fixed without further updates during the training stage to generate counterfactual future trajectories. The reason for using a separate prediction branch may be to minimize the influence of the ego-agent in counterfactual prediction.

To predict future trajectories in the scenarios with the ego-agent, an MLP prediction head may take the final node attributes \tilde{v}ₜⁱ as input and output the means of predicted trajectory distributions of agent i (e.g., \hat{μ}_{t+1:t+T}_{_{f}}^{1,w/Ego}). The pre-trained network parameters in the former setting may be used to enable initialization.

### Interactivity Estimation

An interactivity estimation mechanism may be provided based on the difference between the predicted trajectories. The ego-agent may potentially influence the behavior of surrounding agents that have conflicts in their future paths and negotiate the right of way. The estimated strength of influence indicated by the difference between their future trajectories may quantitatively imply to what extent the ego-agent may try to interact or negotiate with a certain agent, which may be named as an interactivity score (IS) and helps the ego-agent to select a proper occasion to proceed.

According to one aspect, Kullback-Leibler (KL) divergence between the

two trajectory distributions may be given by:

$${x}_{t + 1 : t + {T}_{f}}^{i} \vert {o}_{1 : t} ∼ 𝒩 ( {\hat{μ}}_{t + 1 : t + {T}_{f}}^{i , \frac{w}{Ego}} , \sum ) = 𝒩 ( {\hat{μ}}_{1}^{i} , \sum )$$

$${x}_{t + 1 : t + {T}_{f}}^{i} \vert {o}_{1 : t}^{1 : N + M} ∼ 𝒩 ( {\hat{μ}}_{t + 1 : t + {T}_{f}}^{i , \frac{w}{o} E g o} , \sum ) = 𝒩 ( {\hat{μ}}_{2}^{i} , \sum )$$

to indicate the difference quantitatively, which may be computed by:

$${D}_{K L} ( p ( {x}_{t + 1 : t + {T}_{f}}^{i} \vert {o}_{1 : t} ) \vert \vert p ( {x}_{t + 1 : t + {T}_{f}}^{i} \vert {o}_{1 : t}^{1 : N + M} ) ) = \frac{1}{2} ( Tr ( {\sum }^{- 1} \sum ) - d + {( {\hat{μ}}_{1}^{i} - {\hat{μ}}_{2}^{i} )}^{T} {\sum }^{- 1} ( {\hat{μ}}_{1}^{i} - {\hat{μ}}_{2}^{i} ) + ln ( \frac{det \sum }{det \sum } ) ) = \frac{1}{2} {( {\hat{μ}}_{1}^{i} - {\hat{μ}}_{2}^{i} )}^{T} {\sum }^{- 1} ( {\hat{μ}}_{1}^{i} - {\hat{μ}}_{2}^{i} ) = \frac{1}{2 {σ}^{2}} {‖ {\hat{μ}}_{1}^{i} - {\hat{μ}}_{2}^{i} ‖}^{2} \qquad ( 18 )$$

where σ² may be the constant covariance value in the diagonal of Σ, d may be the dimension of the distributions, Tr(⋅) may denote the trace of a matrix, ⋅^{T} may denote the transpose of a vector, Σ⁻¹ and det Σ may denote the inverse and determinant of the covariance matrix, respectively. Due to the Gaussian assumption with fixed covariance, the KL divergence may reduce to the L₂ distance between the mean vectors of two trajectory distributions multiplied by a constant. The interactivity score (IS) wₜⁱ of agent i at time t may be defined as:

wₜⁱ=∥\hat{μ}_{t+1:t+T}_{_{f}}^{i,w/Ego}−\hat{μ}_{t+1:t+T}_{_{f}}^{i,w/o Ego}∥² (19)

The interactivity scores may be treated as a feature of each agent and used by the policy network. Moreover, the interactivity scores may be used as the weights of prediction errors in the loss function for trajectory prediction, which may be computed by:

$${L}^{T P} = \frac{1}{N + M} {\sum }_{i = 1}^{N + M} {w}_{t}^{i} \cdot {‖ {\hat{μ}}_{t + 1 : t + {T}_{f}}^{i , w / E g o} - {x}_{t + 1 : t + {T}_{f}}^{i , w / E g o} ‖}^{2} \qquad ( 20 )$$

where x_{t+1:t+T}_{_{f}}^{1,w/Egpo} may be the ground truth of future trajectories.

According to one aspect, the architectures of FIGS. 2-3 may integrate auxiliary supervised learning tasks into the reinforcement learning frameworks. Exemplary pseudocode for the training and testing phases may be provided in Algorithm 1 and Algorithm 2, respectively.

### Algorithm 1 Reinforcement Learning with Auxiliary Tasks (Training Phase)

Algorithm 1—Input: initial parameters of the policy network θ₀, value function ϕ₀, clipping threshold ϵ, encoder ψ₀^{Enc}, internal state inference network ψ₀^{ISI}, trajectory prediction head considering the ego vehicle ψ₀^{TP}
1 for k=1, 2, . . . do
2 // Collect a set of trajectories [symbol] ₖ by running the policy πₖ=π(θₖ0) in the environment following the below:
3 for r=1, 2, . . . do
4 for t=1, 2, . . . do
5 Infer the internal states of surrounding vehicles \hat{z}ₜ^{1:N} with the current ψ^{Enc} and ψ^{ISI}
6 Generate the future trajectory hypotheses \hat{μ}_{t+1:t+T}_{_{f}}^{1:N+M,w/Ego} with the current ψ^{Enc} and ψ^{TP}
7 Generate the future trajectory hypotheses \hat{μ}_{t+1:t+T}_{_{f}}^{1:N+M,w/o Ego} with the pre-trained prediction model
8 Compute interactivity scores of other agents by Equation (19)
9 Choose an action for ego-agent using the policy πₖ and obtain the next state from the environment
10 end for
11 end for
12 // Update the learnable networks following the below:
13 Compute the rewards-to-go \hat{R}ₜ
14 Compute the advantage estimates Âₜ using any method of advantage estimation with the current value function V_{ϕk}
15 Update the policy network by maximizing the PPO objective via stochastic gradient ascent with Adam optimizer:

$${θ}_{k + 1} = arg {max}_{θ} 𝔼 [ min ( \frac{{π}_{θ} ( a \vert {o}_{1 : t} , {z}_{t}^{1 : N} , {w}_{t}^{1 : N + M} )}{{π}_{{θ}_{k}} ( a \vert {o}_{1 : t} , {z}_{t}^{1 : N} , {w}_{t}^{1 : N + M} )} \hat{A} , clip ( \frac{{π}_{θ} ( a \vert {o}_{1 : t} , {z}_{t}^{1 : N} , {w}_{t}^{1 : N + M} )}{{π}_{{θ}_{k}} ( a \vert {o}_{1 : t} , {z}_{t}^{1 : N} , {w}_{t}^{1 : N + M} )} , 1 - ϵ , 1 + ϵ ) \hat{A} ) ] \qquad ( 21 )$$

The ground truth internal states zₜ^{1:N} may be used as the input of policy network in the training phase while the inferred internal states \hat{z}ₜ^{1:N} may be used to compute loss function (16)
16 Fit the value function by regression on mean squared error via gradient descent:

$${ϕ}_{k + 1} = arg {min}_{ϕ} {𝔼 ( {V}_{ϕ} ( {s}_{t} ) ϕ - {\hat{R}}_{t} )}^{2} \qquad ( 22 )$$

17 Update the encoder ψ^{Enc}, internal state inference network ψ^{ISI}, and trajectory prediction head ψ^{TP} by minimizing the loss function (16) and (20) via gradient descent
18 end for

### Algorithm 2 Reinforcement Learning with Auxiliary Tasks (Testing Phase)

Algorithm 2—Input: parameters of policy network θ, encoder ψ^{Enc}, internal state inference network ψ^{ISI}, trajectory prediction heads ψ^{TP}
1 // Given a testing scenario, run the policy following the below:
2 for t=1, 2, . . . do
3 Infer the internal states of surrounding vehicles \hat{z}ₜ^{1:N} with current ψ^{Enc} and ψ^{ISI}
4 Generate the trajectory hypotheses \hat{μ}_{t+1:t+T}_{_{f}}^{1:N,w/Ego} and \hat{μ}_{t+1:t+T}_{_{f}}^{1:N,w/o Ego} with ψ^{Enc} and ψ^{TP} and the pre-trained prediction model
5 Compute interactivity scores of other agents by Equation (19)
6 Choose an action aₜ for ego-agent using the policy π_{θ}(aₜ|o_{1:t}, \hat{z}ₜ^{1:N}, wₜ^{1:N+M}) and obtain the next state
7 end for

A graph-based encoder to extract spatiotemporal features from historical observations of one or more of the agents may be provided. An internal state inference module, implemented via the processor, may recognize the traits and intentions of surrounding vehicles. A trajectory prediction module, implemented via the processor, may forecast the future behaviors of other agents with the existence of the ego-agent. The ground truth labels of internal states and future trajectories may be obtained from the simulation environment (e.g., driving simulator) during the training phase, which may be not needed in the testing phase. A pre-trained trajectory prediction module, implemented via the processor, may forecast the future behaviors of other agents without the existence of the ego-agent. The interactivity scores of other agents may be estimated. The policy network may output the action distribution based on the historical observations, inferred internal states, and estimated interactivity scores of surrounding agents.

The explainability may be derived from two aspects: the internal state inference; and the interactivity estimation. On the one hand, navigation based on internal state inference and interactivity estimation may infer the traits and intentions of surrounding vehicles, which may inform the policy network about whether they tend to yield to the ego-agent. The inferred internal state may serve as an explanation for the decision making. On the other hand, the estimated interactivity scores may reflect how much influence the ego-agent may potentially have on surrounding agents. A higher interactivity score may imply that the ego-agent has a higher possibility to be able to influence and negotiate with the corresponding agent to improve driving efficiency.

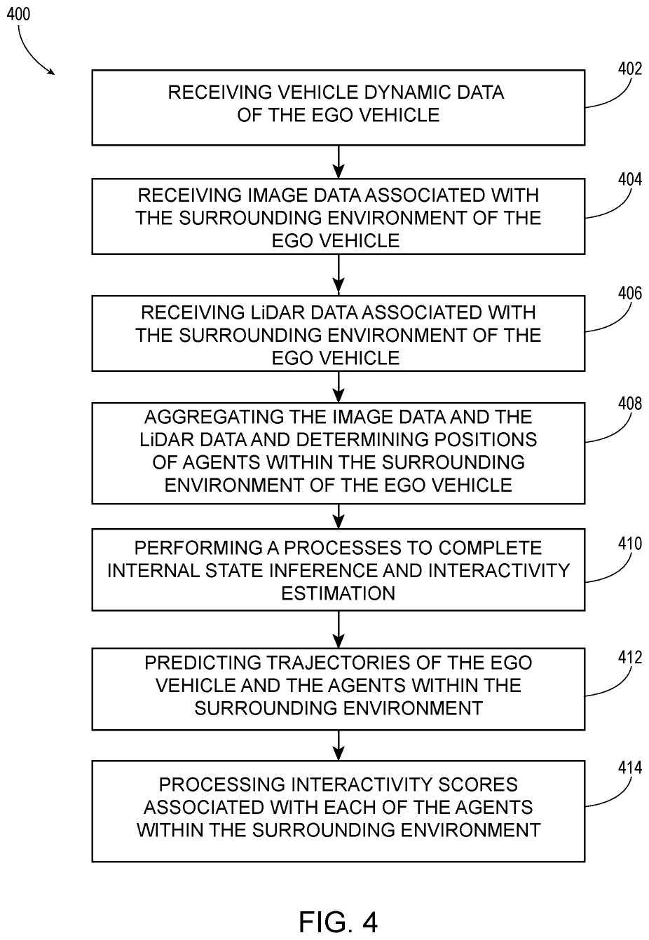

FIG. 4 is an exemplary flow diagram of a computer-implemented method 400 or navigation based on internal state inference and interactivity estimation, according to one aspect. The computer-implemented method 400 for navigation based on internal state inference and interactivity estimation may include receiving 402 vehicle dynamic data associated with an ego-vehicle, receiving 404 image data associated with the surrounding environment of the ego-vehicle, receiving 406 Lidar data associated with the surrounding environment of the ego-vehicle, aggregating 408 the image data and the Lidar data and determining positions and velocities of agents within the surrounding environment for the ego-vehicle, performing 410 a process to complete internal state inference and interactivity estimation (e.g., utilizing a policy for autonomous navigation), predicting 412 trajectories of the ego-vehicle and agents within the surrounding environment, and processing 414 interactivity scores associated with each of the agents with the surrounding environment. Additionally, the computer-implemented method 400 or navigation based on internal state inference and interactivity estimation may include controlling the ego-vehicle based on any of the performing 410, predicting 412, processing 414, etc.

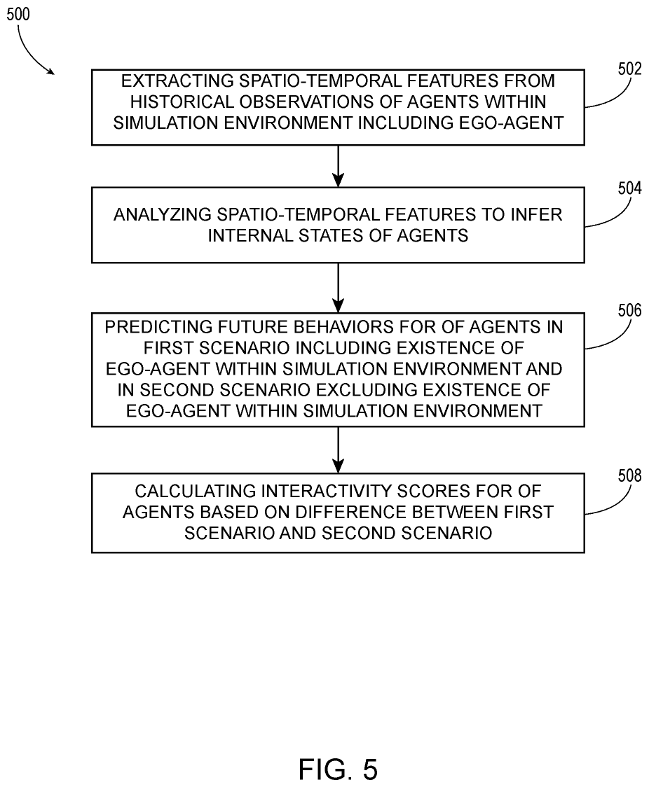

FIG. 5 is an exemplary flow diagram of a computer-implemented method 500 for navigation based on internal state inference and interactivity estimation, according to one aspect. The computer-implemented method 500 for navigation based on internal state inference and interactivity estimation may include training a policy for autonomous navigation by extracting 502 spatio-temporal features from one or more historical observations of one or more agents within a simulation environment including an ego-agent, analyzing 504 the spatio-temporal features to infer one or more internal states of one or more of the agents, predicting 506 one or more future behaviors for one or more of the one or more of the agents in a first scenario including an existence of the ego-agent within the simulation environment and in a second scenario excluding the existence of the ego-agent within the simulation environment, and calculating 508 one or more interactivity scores for one or more of the agents based on a difference between the first scenario and the second scenario.

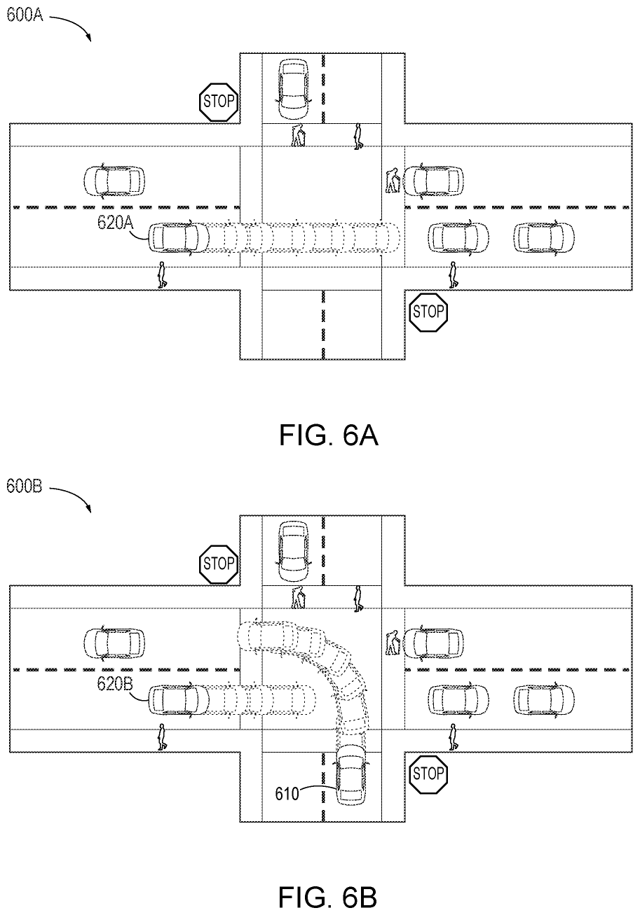

FIG. 6A-6B are illustrations of exemplary scenarios in association with the system 100 for navigation based on internal state inference and interactivity estimation of FIG. 1, according to one aspect. As seen in FIG. 6A, a scenario 600A excluding the existence of the ego-agent within the simulation environment is provided. As seen in FIG. 6B, a scenario 600B including the existence of the ego-agent 610 within the simulation environment is provided. Here, the other agent 620A may freely travel through the intersection. This existence of the ego-agent 610 may impact the decision making, the behavior, etc. of the other agent 620B. Here, the other agent 620B may not freely travel through the intersection without possibly cause a collision.

FIG. 7 is an exemplary architecture 700 in association with the system 100 for navigation based on internal state inference and interactivity estimation of FIG. 1, according to one aspect. FIG. 7 may be a general diagram of the graph-based encoder. The graph-based encoder may include a first long-short term memory (LSTM) layer, a graph message passing layer, and a second LSTM layer. The graph message passing layer may be positioned between the first LSTM layer and the second LSTM layer. Different LSTM networks may be used to extract features for the ego-agent, surrounding vehicles, and pedestrians, respectively. The outputs of the two LSTM layers may be concatenated to generate their final embeddings.

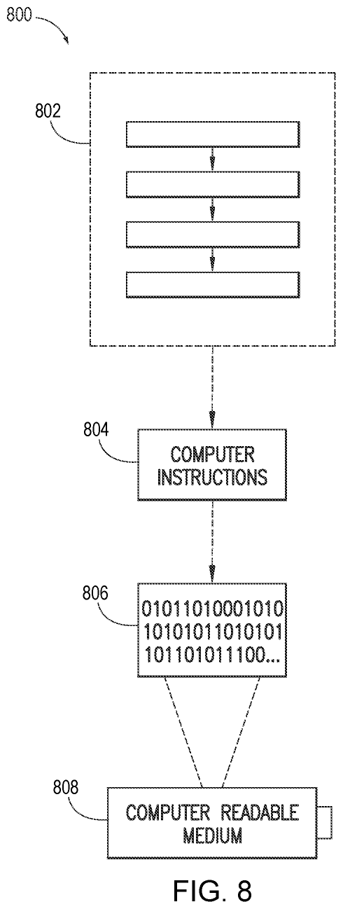

Still another aspect involves a computer-readable medium including processor-executable instructions configured to implement one aspect of the techniques presented herein. An aspect of a computer-readable medium or a computer-readable device devised in these ways is illustrated in FIG. 8, wherein an implementation 800 includes a computer-readable medium 808, such as a CD-R, DVD-R, flash drive, a platter of a hard disk drive, etc., on which is encoded computer-readable data 806. This encoded computer-readable data 806, such as binary data including a plurality of zero's and one's as shown in 806, in turn includes a set of processor-executable computer instructions 804 configured to operate according to one or more of the principles set forth herein. In this implementation 800, the processor-executable computer instructions 804 may be configured to perform a method 802, such as the computer-implemented method 400, 500 of FIGS. 2-5. In another aspect, the processor-executable computer instructions 804 may be configured to implement a system, such as the system 100 for navigation based on internal state inference and interactivity estimation of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 8 and the following discussion provide a description of a suitable computing environment to implement aspects of one or more of the provisions set forth herein. The operating environment of FIG. 8 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

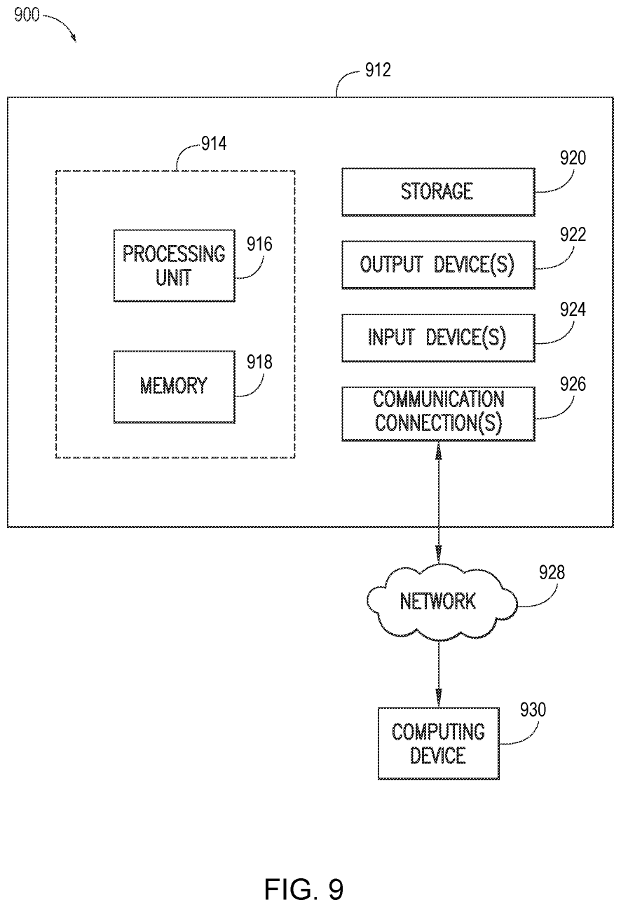

FIG. 9 illustrates a system 900 including a computing device 912 configured to implement one aspect provided herein. In one configuration, the computing device 912 includes at least one processing unit 916 and memory 918. Depending on the exact configuration and type of computing device, memory 918 may be volatile, such as RAM, non-volatile, such as ROM, flash memory, etc., or a combination of the two. This configuration is illustrated in FIG. 9 by dashed line 914.

In other aspects, the computing device 912 includes additional features or functionality. For example, the computing device 912 may include additional storage such as removable storage or non-removable storage, including, but not limited to, magnetic storage, optical storage, etc. Such additional storage is illustrated in FIG. 9 by storage 920. In one aspect, computer readable instructions to implement one aspect provided herein are in storage 920. Storage 920 may store other computer readable instructions to implement an operating system, an application program, etc. Computer readable instructions may be loaded in memory 918 for execution by the at least one processing unit 916, for example.

The term “computer readable media” as used herein includes computer storage media. Computer storage media includes volatile and nonvolatile, removable, and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 912. Any such computer storage media is part of the computing device 912.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 912 includes input device(s) 924 such as keyboard, mouse, pen, voice input device, touch input device, infrared cameras, video input devices, or any other input device. Output device(s) 922 such as one or more displays, speakers, printers, or any other output device may be included with the computing device 912. Input device(s) 924 and output device(s) 922 may be connected to the computing device 912 via a wired connection, wireless connection, or any combination thereof. In one aspect, an input device or an output device from another computing device may be used as input device(s) 924 or output device(s) 922 for the computing device 912. The computing device 912 may include communication connection(s) 926 to facilitate communications with one or more other devices 930, such as through network 928, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for navigation based on internal state inference and interactivity estimation, comprising:
a memory storing one or more instructions; and
a processor executing one or more of the instructions stored on the memory to perform training a policy for autonomous navigation by:
extracting spatio-temporal features from one or more historical observations of one or more agents within a simulation environment including an ego-agent;
analyzing the spatio-temporal features to infer one or more internal states of one or more of the agents;
predicting one or more future behaviors for one or more of the one or more of the agents in a first scenario including an existence of the ego-agent within the simulation environment and in a second scenario excluding the existence of the ego-agent within the simulation environment; and
calculating one or more interactivity scores for one or more of the agents based on a difference between the first scenario and the second scenario.

2. The system for navigation based on internal state inference and interactivity estimation of claim 1, wherein the calculating one or more interactivity scores for one or more of the agents is based on counter factual prediction.

3. The system for navigation based on internal state inference and interactivity estimation of claim 1, wherein one or more of the internal states is an aggressiveness level or a yielding level.

4. The system for navigation based on internal state inference and interactivity estimation of claim 1, wherein one or more of the historical observations of one or more of the agents is a position or a velocity.

5. The system for navigation based on internal state inference and interactivity estimation of claim 1, wherein the extracting the spatio-temporal features from one or more of the historical observations of one or more of the agents is performed by a graph-based encoder.

6. The system for navigation based on internal state inference and interactivity estimation of claim 5, wherein the graph-based encoder includes a first long-short term memory (LSTM) layer, a graph message passing layer, and a second LSTM layer.

7. The system for navigation based on internal state inference and interactivity estimation of claim 6, wherein the graph message passing layer is positioned between the first LSTM layer and the second LSTM layer.

8. The system for navigation based on internal state inference and interactivity estimation of claim 6, wherein an output of the first LSTM layer and an output of the second LSTM layer is concatenated to generate final embeddings.

9. The system for navigation based on internal state inference and interactivity estimation of claim 1, wherein the training the policy for autonomous navigation is based on a Partially Observable Markov Decision Process (POMDP).

10. The system for navigation based on internal state inference and interactivity estimation of claim 1, wherein Kullback-Leibler (KL) divergence is used to measure the difference between the first scenario and the second scenario.

11. A computer-implemented method for navigation based on internal state inference and interactivity estimation, comprising training a policy for autonomous navigation by:
extracting spatio-temporal features from one or more historical observations of one or more agents within a simulation environment including an ego-agent;
analyzing the spatio-temporal features to infer one or more internal states of one or more of the agents;
predicting one or more future behaviors for one or more of the one or more of the agents in a first scenario including an existence of the ego-agent within the simulation environment and in a second scenario excluding the existence of the ego-agent within the simulation environment; and
calculating one or more interactivity scores for one or more of the agents based on a difference between the first scenario and the second scenario.

12. The computer-implemented method for navigation based on internal state inference and interactivity estimation of claim 11, wherein the calculating one or more interactivity scores for one or more of the agents is based on counter factual prediction.

13. The computer-implemented method for navigation based on internal state inference and interactivity estimation of claim 11, wherein one or more of the internal states is an aggressiveness level or a yielding level.

14. The computer-implemented method for navigation based on internal state inference and interactivity estimation of claim 11, wherein one or more of the historical observations of one or more of the agents is a position or a velocity.

15. A navigation based on internal state inference and interactivity estimation autonomous vehicle, comprising:
a memory storing one or more instructions;
a storage drive storing a policy for autonomous navigation;
a processor executing one or more of the instructions stored on the memory to perform autonomous navigation by utilizing the policy for autonomous navigation, wherein the policy for autonomous navigation is trained by:
extracting spatio-temporal features from one or more historical observations of one or more agents within a simulation environment including an ego-agent;
analyzing the spatio-temporal features to infer one or more internal states of one or more of the agents;
predicting one or more future behaviors for one or more of the one or more of the agents in a first scenario including an existence of the ego-agent within the simulation environment and in a second scenario excluding the existence of the ego-agent within the simulation environment; and
calculating one or more interactivity scores for one or more of the agents based on a difference between the first scenario and the second scenario; and
a controller controlling the navigation based on internal state inference and interactivity estimation autonomous vehicle according to the policy for autonomous navigation and inputs from a vehicle sensor.

16. The navigation based on internal state inference and interactivity estimation autonomous vehicle of claim 15, wherein the calculating one or more interactivity scores for one or more of the agents is based on counter factual prediction.

17. The navigation based on internal state inference and interactivity estimation autonomous vehicle of claim 15, wherein one or more of the internal states is an aggressiveness level or a yielding level.

18. The navigation based on internal state inference and interactivity estimation autonomous vehicle of claim 15, wherein one or more of the historical observations of one or more of the agents is a position or a velocity.

19. The navigation based on internal state inference and interactivity estimation autonomous vehicle of claim 15, wherein the extracting the spatio-temporal features from one or more of the historical observations of one or more of the agents is performed by a graph-based encoder.

20. The navigation based on internal state inference and interactivity estimation autonomous vehicle of claim 19, wherein the graph-based encoder includes a first long-short term memory (LSTM) layer, a graph message passing layer, and a second LSTM layer.
